(19) United States
(12) Patent Application Publication
(10) Pub. No.: US 2025/0277762 A1
(43) Pub. Date: Sep. 4, 2025

(54) METHOD AND SYSTEM FOR SINGLE-SHOT FIELD CHARACTERIZATION USING SPECKLE-CORRELATION SCATTERING MATRIX

(71) Applicants: TOMOCUBE, INC., Daejeon (KR); KOREA ADVANCED INSTITUTE OF SCIENCE AND TECHNOLOGY, Daejeon (KR)

(72) Inventors: YongKeun PARK, Daejeon (KR); KyeoReh LEE, Daejeon (KR)

(21) Appl. No.: 19/063,348

(22) Filed: Feb. 26, 2025

(30) Foreign Application Priority Data
Feb. 29, 2024 (KR) 10-2024-0030086

(51) Int. Cl. G01N 23/20008

(52) U.S. Cl. CPC G01N 23/20008

(57) ABSTRACT

The present disclosure relates to a method and a system for single-shot field characterization using a speckle-correlation scattering matrix, which may be configured to measure a speckle pattern for an incident field of an X-ray pulse, measure a speckle-correlation scattering matrix representing complex value information of the incident field from the speckle pattern, estimate an estimate for a characteristic of the incident field from eigenvalue decomposition of the speckle-correlation scattering matrix, and derive a final solution from the estimate through an amplitude flow.

### BACKGROUND

The present disclosure relates to a method and a system for single-shot field characterization using a speckle-correlation scattering matrix (SSM).

### BACKGROUND OF THE INVENTION

Incident field characterization is important in most imaging systems because it is closely related to the quality of the image obtainable, the spatial resolution, and the sample information. Coherent diffractive imaging (CDI) is no exception. However, its importance is even greater in CDI because the incident field (or probe) may not be obtained independently by measuring the “background” signal without a sample. Therefore, various probe separation techniques have been introduced, including known-probe assumption, pre-adjustment of the probe, and simultaneous restoration of the probe and the object based on scanning measurements, to obtain an accurate image of the object from the diffraction pattern. The last technique is called ptychography, which is one of Garfield's popular probe characterization techniques in synchrotron sources.

Single-particle imaging (SPI) is a type of CDI, but uses femtosecond X-ray pulses made in an x-ray free-electron laser (XFEL) to overcome the limits of radioactive damage to biological samples. By introducing the “diffraction before destruction” method, only the incident X-ray quantum flux will be a theoretical factor that impairs the spatial resolution of the SPI. Therefore, the size and quality of the X-ray focus has become one of the important factors for the quality of the overall SPI. As a matter of course, the demand for focus diagnostic procedures for XFELs has increased.

However, field characterization in XFEL is more challenging than in synchrotron light sources. XFELs exhibit inherent pulse-to-pulse variations in intensity, position, and wavefront phase due to the stochastic nature of self-amplified stimulated emission (SASE). This instability interferes with the direct application of tychography, which originally assumed a stable incident field. Although various tycographic efforts have successfully addressed position and wavefront deviations, the need for multiple observations (or sufficient oversampling) still remains a problem in the field-of-view and real-time focus diagnostics of SASE pulses.

Various single-shot field characterization techniques based on Hartmann sensors, grating-based shearing interferometry, and speckle tracking have been introduced in XFEL. These single-shot techniques are mostly based on approximate phase grating measurements followed by two-dimensional integrations useful for some approximate illumination. Nevertheless, due to the integration process, it is often vulnerable to approximate phase ambiguities (at low intensity), slowly varying phases (at small tears), singularities in the inversion filter (at large tears), and integration path dependence (due to phase residuals). These drawbacks reduce their usefulness, and single-shot techniques have been used limitedly only in slightly mismatched or reduced situations.

### SUMMARY

### Technical Problem

The present disclosure provides a method and a system for characterizing a single-shot field using a speckle-correlation scattering matrix.

### Technical Solution

In the present disclosure, a method of single-shot field characterization using a speckle-correlation scattering matrix of a computer system may include a step of measuring a speckle pattern for an incident field of an X-ray pulse, a step of measuring a speckle-correlation scattering matrix representing complex value information of the incident field from the speckle pattern, a step of estimating an estimate for a characteristic of the incident field from eigenvalue decomposition of the speckle-correlation scattering matrix, and a step of deriving a final solution from the estimate through an amplitude flow.

In the present disclosure, a system for single-shot field characterization using a speckle-correlation scattering matrix may include a speckle measurement module configured to measure a speckle pattern for an incident field of an X-ray pulse, an SSM measurement module configured to measure a speckle-correlation scattering matrix representing complex value information of the incident field from the speckle pattern, and a characterization module configured to estimate an estimate from eigenvalue decomposition of the speckle-correlation scattering matrix and to derive a final solution from the estimate through an amplitude flow.

### Advantageous Effects

According to the present disclosure, successful field reconstruction is possible using a speckle-correlation scattering matrix. That is, by measuring a speckle-correlation scattering matrix representing complex value information of an incident field from a speckle pattern for the incident field, a characteristic for the incident field may be obtained through the speckle-correlation scattering matrix. This may increase the accuracy of the single-shot and increase its usability.

### BRIEF DESCRIPTION OF THE DRAWINGS

FIG. 1 is a diagram illustrating a diffuser designed as an X-ray imaging lens according to the present disclosure.

FIG. 2 is a diagram illustrating experimental preparation and diffuser of coherent speckle-correlation imaging (CSI) according to the present disclosure.

FIG. 3 is a diagram illustrating a sample field and resolution analysis obtained for CSI according to the present disclosure.

FIG. 4 is a diagram illustrating Fourier ring correlation (FRC) results for CSI according to the present disclosure.

FIG. 5 is a diagram illustrating a resolution reference for an L₁-L₂ plane for CSI according to the present disclosure.

FIG. 6 is a diagram illustrating stitched phase images for CSI according to the present disclosure.

FIG. 7 is a diagram illustrating a field characterization setting for a speckle-correlation scattering matrix (SSM) according to the present disclosure.

FIG. 8 is a diagram illustrating a field acquisition order for an SSM according to the present disclosure.

FIG. 9 is a diagram illustrating an experimental setup for an SSM according to the present disclosure.

FIG. 10 is a diagram illustrating field characterization experiment results for an SSM according to the present disclosure.

FIG. 11 is a diagram illustrating inter-pulse variation for an SSM according to the present disclosure.

FIG. 12 illustrates a computer system for single-shot field characterization using SSM according to the present disclosure.

FIG. 13 illustrates a method of a computer system for single-shot field characterization using SSM according to the present disclosure.

### DETAILED DESCRIPTION

Various embodiments of the present disclosure are described below with reference to the accompanying drawings.

### Interference Speckle-Correlation Imaging (CSI)

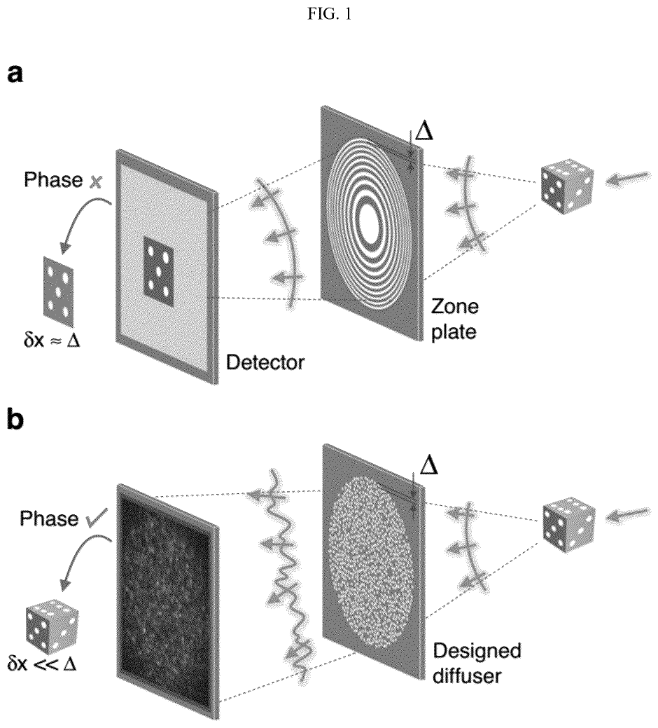

The present disclosure introduces CSI in X-rays. In CSI, the present disclosure converted a sample field into random speckles before making measurements using an X-ray diffuser. Although the phase of a speckle is likewise not measurable, a sample field with complex values may be uniquely reconstructed through a magnitude image through pseudorandomness of the speckle. The CSI of the present disclosure achieves an image resolution of 13.9 nm at 5.46 keV using an X-ray diffuser designed after the sample (FIG. 1) instead of a zone plate; this is much smaller than the feature size of the diffuser used (300 nm). The oversampling ratio and setup requirements are discussed with respect to the resolution of the image and the field of view of the sample obtained.

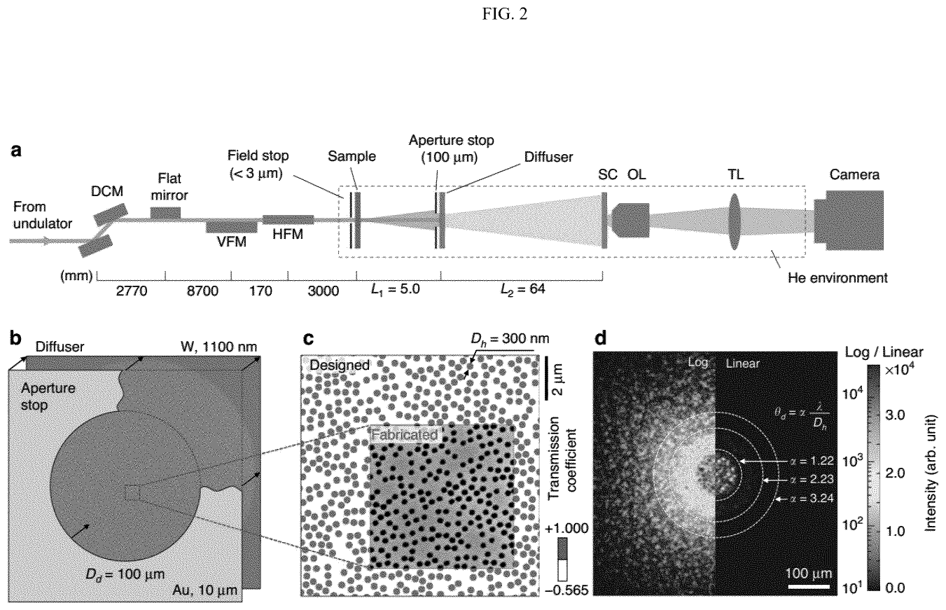

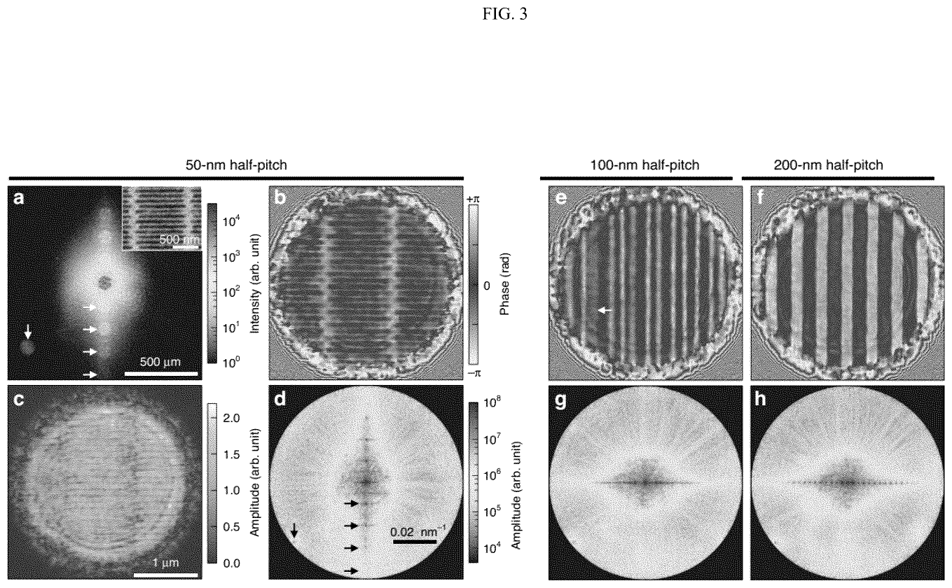

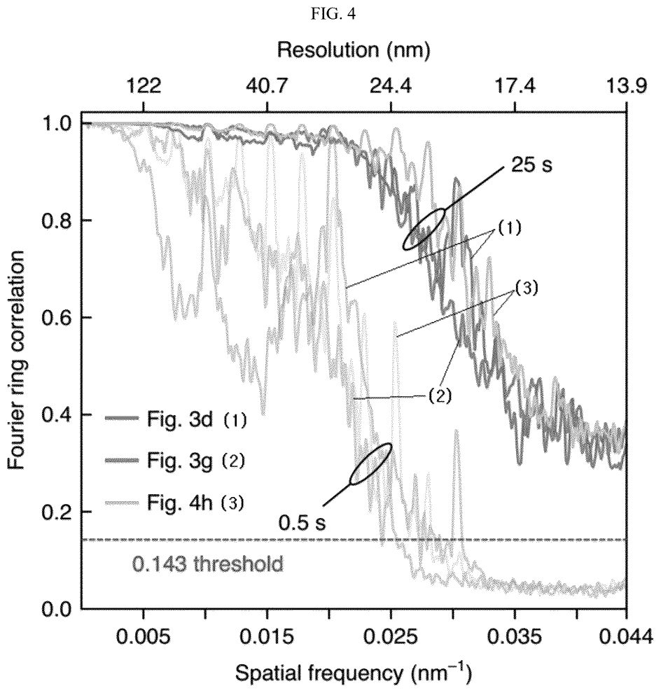

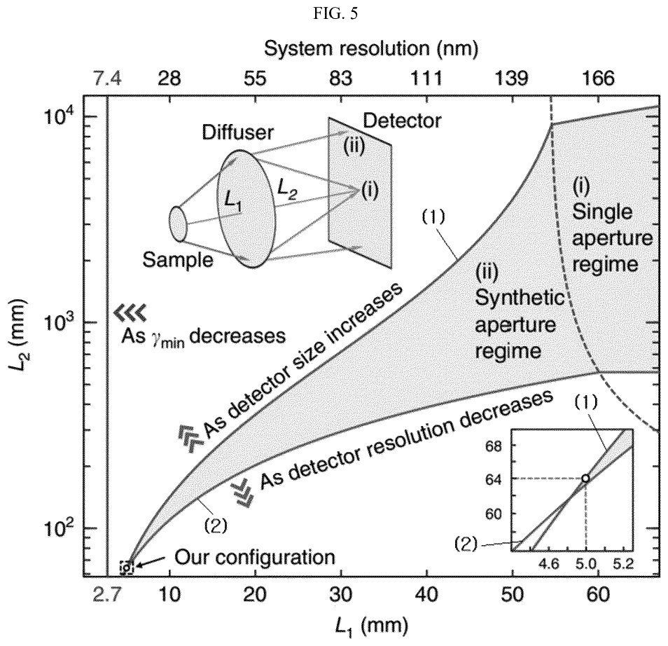

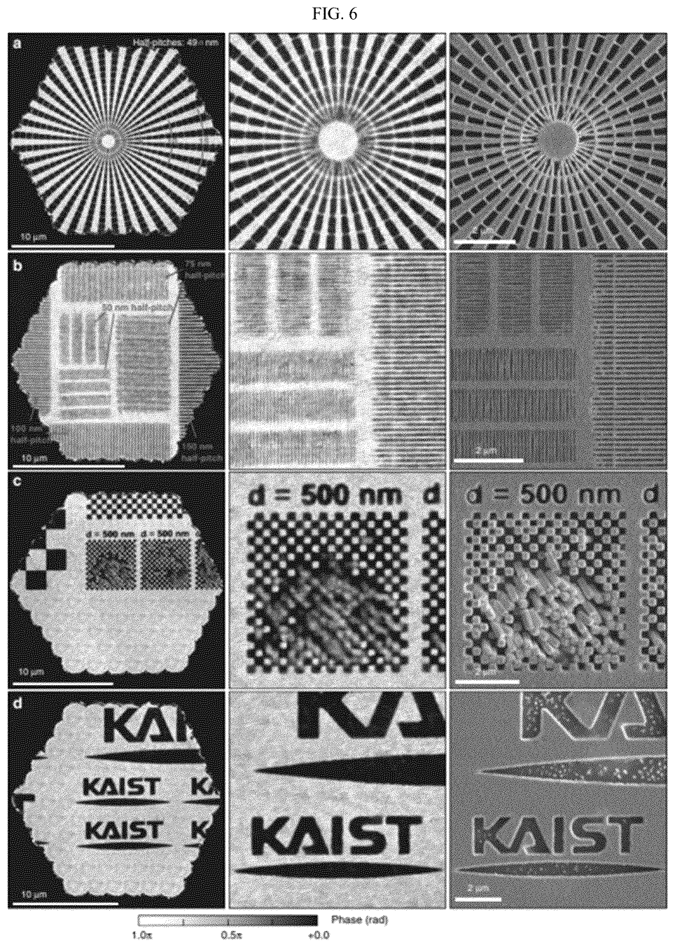

Hereinafter, it is specifically described in connection with the CSI. FIG. 1 is a diagram illustrating a diffuser designed as an X-ray imaging lens according to the present disclosure. FIG. 2 is a diagram illustrating CSI experiment preparation and a diffuser according to the present disclosure. FIG. 3 is a diagram illustrating a sample field and resolution analysis obtained for CSI according to the present disclosure. FIG. 4 is a diagram illustrating FRC results for CSI according to the present disclosure. FIG. 5 is a diagram illustrating a resolution reference for an L₁-L₂ plane for CSI according to the present disclosure. FIG. 6 is a diagram illustrating stitched phase images for CSI according to the present disclosure.

### 1. Results

### Experimental Preparation

The experimental preparation of CSI is shown in (a) of FIG. 2 (see ‘method’ described below). A coherent X-ray beam (5.46 keV) was used at the 9C beamline of Pohang Light Source II (PLS-II). A field stop (<3.0 μm) was placed in front of the sample to maintain spatial interference and remove background signals outside the sample area. A diffuser is a sputtered tungsten film overlying a silicon nitride membrane with holes that are etched to a size of 300 nm and have no order but are located ((b) of FIG. 2). The thickness of the tungsten and the density of the holes were designed to produce a well-formed speckle pattern at quantum energies given by minimizing the unmodulated term of the diffuser (q=0). The diameter of the diffuser is defined by an aperture stop (100 μm). This is because the positions of the holes are predetermined, the transfer function of the diffuser ((c) of FIG. 2) is known, and the output field according to a given input field may be calculated. The experimental speckle pattern without sample is shown in (d) of FIG. 2. We identified the size of the diffractive pattern lobe and the size of the hole in the diffuser and the thickness of the tungsten fabricated through the central unmodulated term portion, respectively. As intended, speckle grains that are observable without strong non-modulation term are also seen in the linearly scaled image.

Nevertheless, potential errors during fabrication of the diffuser may cause differences between the calculated and measured speckle patterns, which may reduce the field recovery reliability of the CSI. For example, the hole size of the diffuser may differ due to finely less shaving (more shaving) during fabrication. Fortunately, we have found that the grain pattern of the speckle pattern does not differ appreciably even with the difference in hole size. This is because speckle pattern of a detector consists of far-field diffraction of the holes, and the phase information of each hole is mainly related to the position of the hole rather than the size of the hole.

Potential errors in diffuser alignment may also reduce the field recovery reliability of CSI. Diffuser misalignment represents the difference between the expected diffuser hole position and the actual diffuser hole position, which may result in significant decorrelation in the speckle pattern. To minimize the error, we introduced a mathematical fine-tuning procedure to apply the actual position and roll angle of the diffuser. Since even a small deviation may severely reduce the field recovery reliability, the exact position and roll angle may be determined by maximizing the field recovery reliability. We also supplemented the blurring effect of a scintillator through deconvolution of point spread function (PSF). The PSF of the sensing system is measured by providing a sub-diffraction-limit X-ray focused on a scintillator (see ‘method’ described below). Note that this correction step is necessary after the optical system is ready.

### Restoration Flow

The CSI field reconstruction flow has two main steps: an initial guess of the sample field from the speckle-correlation scattering matrix; and an error reduction algorithm that derives a final solution with the initial guess. In this study, we use amplitude flow (AF) for the error reduction step. Please find a detailed description of each step in the method.

The overall reconstruction flow of CSI requires only a measured intensity speckle, a predefined transmission matrix (TM), and pseudorandomness of the speckle. The TM is calculated through the transfer function of the designed diffuser ((c) of FIG. 2), and is calculated through the free-propagation distance L₁ before the diffuser and the length L₂ after the diffuser. Random X-ray diffusers such as sandpaper may not be used for CSI unless their transfer function has been calibrated beforehand. Note that the sample field may not be obtained by simple TM inversion since the phase of the speckle field may not also be measured. Therefore, it should be emphasized that TM-inversion-based imaging techniques or additional phase-measurement techniques using spatially inconsistent luminescence are fundamentally different from CSI. Instead, we exploit the pseudo-randomness of speckle in CSI. This is the main idea behind the uniqueness of the solution, and leads to a universal application of the field recovery algorithm. This allows the speckle field to be treated as Gaussian random variables, which is a common prerequisite for the Isserlis' theorem and the stability of AF iterations (see ‘method’ described below) in SSM design (see ‘method’ described below). The entire reconstruction took 40-70 seconds using a GPU (GeForce GTX 1080 Ti, NVIDIA Corp.).

### Field Retrieval Results

In the first CSI demonstration using X-rays, a grating structure engraved on a sputtered tungsten (700 nm thick) film was imaged. The speckle pattern observed on a 50 nm half-pinch grating is shown in (a) of FIG. 3. We collected a hundred camera frames to improve the signal-to-noise ratio (SNR) without saturation. It takes 250 ms to take one frame; that is, the total acquisition time takes 25 seconds. A total of ˜1.6×10¹¹ quanta were used, in other words, ˜1. 6×10⁹ quanta per frame.

The corresponding sample fields obtained are indicated in (b) and (c) of FIG. 3. Phase clearly visualizes the grating structure to a depth where the lines are not evenly etched ((b) of FIG. 3). Amplitude images provide less contrast compared to the phase image ((c) of FIG. 3). Diffraction coming from the field stop is observed from both the amplitude and phase images. Reciprocal space of the sample field is shown in (d) of FIG. 3. Higher diffraction orders of the grating are easily observed, which implies the high-definition imaging capability of CSI. The results from the 100 nm and 200 nm half-pinch gratings are shown in FIG. 3 (c) to (h). Fine aperiodicity and some collapsed lines (arrows in the drawing) are observed in the 100 nm half-pinch grating ((c) of FIG. 3). Well established lines were observed on a 200 nm half-pinch grating ((f) of FIG. 3). The tungsten portions consistently show a retardation by −2 rad, which is consistent with the theoretical value of a 700 nm thick tungsten film. The observed phase is negative because the refractive index of tungsten is less than the total.

The sample zones in real space and reciprocal space are set according to the diameter of the hole used. The real space zone is set to 3 μm (Ds) slightly larger than the hole stop. The reciprocal space is bandlimited by a mathematical field of view of a given system ½D_{d}/L₁=0.01, where D_{d} is the diameter of the diffuser (100 μm). Although CSI does not use any pedestal constraints in the field recovery algorithm, two apertures are still introduced to govern the various initial optical modes in the setup, and to minimize unwanted signals. Note that existing imaging systems (e.g., digital cameras) often have an aperture in the same role.

The sampling zone may, however, be set independently of the experimental combination. When we set the sampling zone smaller than the actual sample signal, the signal outside the defined zone is not recognizable and will be classified as noise in the reconstruction process. Similarly, when we set a larger sampling zone, an extra empty field will be retrieved. Such inconsistent settings are inefficient in sampling and computation speed, but may be useful depending on the application. For example, low-NA reconstruction would be preferred for optical alignment because of the faster reconstruction speed. This unrestricted sampling is a major advantage of CSI compared to CDI-based imaging techniques.

The CSI restores the optical field independent of the sample. Therefore, when there is a deviation in the sample axis position, a non-focused sample field is naturally observed. The sample field shown in FIG. 3, however, was refocused to the surface of the same sample through mathematical propagation (28 μm elevation) for a clearer visualization.

### Obtained Image Resolution

To quantify the spatial resolution, we calculated the Fourier ring correlation (FRC) of the acquired sample field. We randomly divided the 100 speckle images measured into two sets of 50, each added separately. Two independent sample fields were obtained and the FRC between them was calculated. Ten FRC results were calculated for the other substitutions and averaged. A consistent noise signal was observed at the bottom-left corner of the speckle pattern, resulting in a high-frequency signal in the reciprocal space (FIGS. 3A and 3D, vertical arrows). We excluded terms to prevent erroneous high correlations in the FRC calculation.

The FRC results are indicated in FIG. 4. The FRCs of the three grating samples are similarly attenuated with increasing spatial frequency. According to the 0.143 threshold, all three grating samples used the NA of the imaging system as a whole with a corresponding image quality of δx=0.61λ/NA at 13.9 nm, which corresponds to the reciprocal space showing the scattering signal extension to the hole edge ((d), (g), (h) of FIG. 3). We may see the high-angle sample diffraction ((a) of FIG. 3, horizontal arrows) in the speckle image, which is directly associated with the high frequency signal in the reciprocal zone (FIG. 3 (d), horizontal arrows. However, the resolution of the sample field depends on the SNR. Weak sample scattering signals or strong detection noise may reduce the effective spatial bandwidth of the acquired sample field. To demonstrate this, we randomly selected one frame per set (instead of 50 frames) and followed the same steps to calculate the FRC. This calculation shows a shorter acquisition time and lower SNR. As expected, the corresponding FRC results decay faster and cross the resolution threshold on the order of ˜0.025 nm-1, which means a resolution of 24.4 nm (FIG. 4, light color).

### Resolution Limits

According to the experimental results of FIGS. 3 (a) to (h), the obtained sample resolution (13.9 nm) is far less than the diffuser hole diameter (Dₕ=300 nm). This is an important advantage of solving practical problems in the manufacturing process, especially compared to X-ray microscopy using zone plates. One question then arises: What is the highest resolution that may be obtained with a given diffuser? We have found that in the current technique, the resolution limit is derived from the oversampling standard of the reconstruction algorithm.

$$δ {x}_{m i n} = \frac{1}{2} {D}_{h} \frac{{D}_{s}}{{D}_{d}} ( \sqrt{{γ}_{m i n}} - 1 ) \qquad [ Equation 1 ]$$

Ds is the diameter of the sample FOV and rₘᵢₙ is the minimum oversampling ratio of stable field counts (see method). The Equation 1 is proportional to Dh. The smaller the Dₛ, the finer the resolution limit, which makes sense in terms of space-bandwidth product (SBP) conservation. At rₘᵢₙ=4, which is an empirically known minimum in the absence of noise, the limit of ideal resolution of a given diffuser is

$$\frac{1}{2} {D}_{h} {D}_{s} / {D}_{d} ) .$$

From the Equation 1, the resolution limit of the current system is 7.4 nm (Dₕ=300 nm, D_{d}=100 μm, Ds=3 μm, rₘᵢₙ=7), which is smaller than the experimentally tested resolution (13.9 nm). This comes from two additional situations related to resolution and observation system (see method). We have to carefully choose L and L₂ which are suitable for the grain s_{ize} and choose a speckle pattern which is suitable for the detector.

One fundamental and two realistic situation is illustrated above the L₁-L₂ plane of FIG. 5. The hatched zones represent possible L₁ and L₂ satisfying all the conditions. Detector resolution and size conditions provide lower and upper ranges of L₂, respectively. The minimum possible L₁ value is defined by the realistic condition rather than the fundamental condition. We may approach the resolution limit by increasing the size of the detector or reducing the resolution of the detector (FIG. 5). In this study, experimental parameters such as L₁, L₂, aperture diaphragm diameter (<Dₛ), and field diaphragm size (=D_{d}) were determined by this theoretical analysis.

### Large FOV Imaging Through Stitching

To demonstrate the versatility of CSI, we measured a sample with an extended FOV by stitching several holographic images. samples were scanned by moving the bottom along a hexagonal grid at intervals of 1.8 μm. In order to cover the ˜21 μm sample field transversely, 91 scan points were used. For fast scans, we used a shorter acquisition time per scan point (250 ms), but also reduced SNR and resolution (FIG. 4). The entire scan procedure consumed approximately 35 seconds, excluding data transfer time. The same tungsten film (700 nm thick) sputtered with Siemens stars, grating arrays, checkerboard patterns, and university logo patterns is imaged (FIG. 6). Aperiodic and complex forms of phase distribution have also been restored. This is shown in the collapsed checkerboard ((c) of FIG. 6) and letters (FIG. 5 (d)). The fine structures were consistently restored ((c) and (d) of FIG. 6). Nevertheless, a slight reduction in quality may be found due to the shorter acquisition time (e.g. 50 nm half pitch grating in FIG. 6 (b)). Unlike in tychography, the sample fields are obtained independently before the stitching step in CSI. This may be useful if there is a realistic error in the sample scan position. We experienced a significant position error in the sample scan step, which is the reason for the irregularly shaped image in FIG. 6. The actual scan position was mathematically adjusted based on the image correlation between adjacent and scan points.

Nevertheless, compared to tychography, insertion of a diffuser may not be preferred in some cases due to unavoidable quantum losses from the diffuser. For example, the calculated average transmission rate of the tungsten diffuser used is 56.5% (see ‘method’ described below). Reduced quantum efficiency may be problematic because the spatial resolution of X-ray imaging is often limited by quantum flux. However, this may be mitigated by using an X-ray diffuser made of a material with a lower atomic number. In our particular configuration, the quantum efficiency may be noticeably increased by replacing the scintillator-based detector with a quantum-counting X-ray detector.

### 2. Discussion

We proposed CSI in X-rays and showed it experimentally. A designed X-ray diffuser was used to convert the speckle pattern in the sample field. Based on speckle pseudo-randomness, the SSM and AF algorithms were applied to obtain high-definition sample fields from the measured speckle patterns. CSI performance was shown across various samples. The resolution limits and the appropriate system configuration were examined theoretically for given experimental parameters.

We expect CSI to be widely used in various studies and to be extended to various samples, different models and different X-ray energies. One promising application point is X-ray tomography, which has the same principle as optical diffraction tomography. The new use of the sample rotational pedestal allows for field measurements of different sample poses, providing a distribution of the three-dimensional refractive index of the sample. The single-shot function of CSI may be easy for short measurements or time-laps measurements. Another promising application point is the introduction of XEFL sources, which are essential for high-definition X-ray imaging of biological samples to avoid radioactive destruction. Thanks to its single-shot and constraint-free functions, CSI will be an excellent imaging technique for XFEL, especially for samples with ambiguous backing. An additional beam block may be needed to prevent damage to the diffuser from X-ray pulses.

Without a sample, CSI may be utilized to characterize the X-ray beam. The spatial characteristics of both the amplitude and phase of the X-ray beam may be achieved through the same configuration and field recovery, which may be used to measure the transfer function of the optics or to measure the aberration of the X-Ray optics. Real-time measurement of the beam wavefront is also possible by reducing the acquisition image resolution. We expect CSI to be used for alignment of X-ray sources and maintenance tools (e.g., alignment of focus optics).

A mixed field of the initial field and its respective microstates may also be obtained through several eigenvectors of the SSM (rather than one, see method described below). Although similar to mixed-state tychography, the single-shot condition of the speckle-correlation technique may once again be useful. Speckle-correlation based imaging may even be used for spatially inconsistent sources using memory effects and the aperiodicity of speckle patterns.

### 3. Method

### Experimental Construction

The experiments were carried out using the 9C beam line of PLS-II in Korea. The configuration is shown in (a) of FIG. 2. A double-crystal monochromator (DCM) and a flat glass were used to select the appropriate X-ray energy (5.46 keV) and filter out the harmonic frequency, respectively. X-ray energy was set to give a π-phase retardation of a portion of the diffuser (tungsten of 1100 nm thick). A Kirkpatrick-Bacz (KB) mirror pair was used to increase the flux of the samples. The quantum flux density at the sample position is ˜1.3×10¹⁵ quantum/s/mm². A field stop (<3.0 μm) is installed below 0.1 mm forward from the sample; this provides a quantum flux of ˜6.4×10⁹ per second for a 2.5 μm diameter field stop. Spatial coherence is ensured by the slits in front of the DCM. The horizontal and vertical slits used are 40 μm and 200 μm in size, respectively, and the corresponding focal points are 9.4 μm and 5 μm (maximum width at half maximum).

Samples were placed in linear stages for sample scans (Q-545.140, Physik Instrumente GmbH). The designed diffuser was placed in the L₁=5.0 mm backward direction from the sample. An aperture stop (100 μm) was installed within 0.15 mm from the diffuser. A field stop and the aperture stop were made using a focused ion beam (FIB) on a 10 μm thick gold film (AU-173174, The Nilaco Corp.). A Tb:LSO scintillator (Tb³⁺:Lu2SiO₅, 11.2 μm thick, λ_{sc}=542 nm) placed on a YSO plate (Yb₂SiO₅ 170 μm thick) was used as the X-ray detector. The scintillator lies L₂=64 mm backwards from the diffuser. An optical microscope consisting of objectives (NA=0.4, ×10, UPLSAPO10×, Olympus Corp.), tube lenses (f=180 mm, TTL180-A, Thorlabs, Inc.), and a sCMOS camera (6.5 μm, 2048×2048, Zyla 4.2 PLUS, Oxford Instruments plc) was used for speckle pattern measurement. The size of the pixel corresponding to the scintillator and the size of the camera sensor are 650 nm and 1.33×1.33 mm², respectively. The sample chamber is filled with helium to prevent X-rays from scattering from the air.

### X-Ray Diffuser Design

In CSI, the diffuser should provide a speckle field that may be treated as a Gaussian random variable. To accomplish this, it is important to minimize the non-modulation term ∫∫_{S}_{_{d}}t_{d}(x, y)dxdy, where t_{d}(x, y) is the transfer function of the diffuser and S_{d} is the area of the diffuser. Since our diffuser is a binary modulator, it may be written as t_{W}(S_{d}−NₕSₕ)+NₕSₕ, where Nₕ is the number of holes, Sₕ is the area of the holes, and t_{w} is the tungsten transfer rate (FIG. 2 (c)). Therefore, the non-modulation terms may be minimized using this.

$${N}_{h} = \frac{{t}_{W}}{{t}_{W} - 1} \frac{{S}_{d}}{{S}_{h}} \qquad [ Equation 2 ]$$

Here, t_{w} should be a real number and a negative number (or π-delayed) to establish Equation 2. To determine the Nₕ, we compared the t_{w} with and without the tungsten film and found that t_{w}=−0.565. The magnitude of t_{w} was smaller than the predicted value (0.625) calculated through the tungsten refractive index. This difference may have resulted from additional scattering losses from the nanostructures of the sputtered tungsten. Based on equation (2) and t_{w}, we designed a diffuser with Nₕ holes randomly placed in zone S. The diameter of the hole (300 nm) is based on fabrication tests from ZonePlates Ltd., UK, and the minimum allowed distance between the centers of the holes (330 nm) was empirically derived from mathematical assumptions. We have found that when the center-to-center distance is too long, it leads to a periodic (hexagonal) arrangement of holes, which is inadequate for a random diffuser. Average transmission rate of diffuser may be calculated through

$$\frac{1}{{S}_{d}} \int {\int }_{{S}_{d}} {\vert {t}_{d} ( x , y ) \vert}^{2} dxdy ,$$

where −t_{w}=0.565 according to Equation 2.

### PSF Measurement

The PSF measurement was performed on the same beam line without focusing mirrors. A zone plate with a 300 μm diameter and a 60 nm outermost zone was used with a 50 μm diameter central aperture. The focal length corresponding to the zone plate is 79.2 nm, which is also the axial distance between the scintillator and the zone plate. A 50 μm diameter order-sorting hole (OSA) was placed in between. The lateral and axial positions of the zone plate and OSA were fine-tuned using a fine linear stage (AG-LS25, Newport Corp.).

The size of the X-ray focus is 73.2 nm, which is much smaller than the diffraction limit of the optical microscope used (827 nm). We attenuated the X-rays sufficiently to prevent damage and saturation of the scintillator.

### Speckle-Correlation Scattering Matrix (SSM)

If the sample field x∈C^{N} is transformed into the speckle field y∈C^{M} as it passes through the system, the transmission matrix (TM) T∈C^{M×N} satisfies y=Tx, where N and M are the number of spatial modes of the sample and the number of spatial modalities of the speckle, respectively. The SBP was calculated to quantify the number of modes. For example, N is the sum of the areas defined by the real sample zone and the reciprocal sample zone. For the results of FIGS. 3 and 6, we have N=43,003 and M=778,414.

Since we may not measure the phase of y, the measured speckle pattern becomes I=y*∘y, where ∘ represents the sum of element-wise. Using TM and the measured speckle pattern, the SSM Z∈C^{N×N} may be calculated as follows.

$${Z}_{ij} = \frac{〈 {t}_{i}^{*} ◦ {t}_{j} ◦ {y}^{*} ◦ y 〉 - 〈 {t}_{i}^{*} ◦ {t}_{j} 〉 〈 {y}^{*} ◦ y 〉}{〈 {t}_{i}^{*} ◦ {t}_{i} 〉 〈 {t}_{j}^{*} ◦ {t}_{j} 〉} \qquad [ Equation 3 ]$$

Here, tᵢ is the i-th column of the TM vector, and the bundle table represents the average of the vector elements

$$( 〈 \cdot 〉 = \frac{1}{M} {\sum }_{i = 1}^{M} ) .$$

The column vector ti is another speckle field tᵢ=Teᵢ, where eᵢ is the i-th basis vector of the sample field x=Σᵢ^{N} xᵢeᵢ.

Since all vectors (tᵢ*, tⱼ, y*, and y) in the first term of the molecule of Equation 3 are speckle fields that may be treated as Gaussian random variables, we analyzed the term using the Isserlis' theorem.

$$〈 {t}_{i}^{*} ◦ {t}_{j} ◦ {y}^{*} ◦ y 〉 = 〈 {t}_{i}^{*} ◦ {t}_{j} 〉 〈 {y}^{*} ◦ y 〉 + 〈 {t}_{i}^{*} ◦ y 〉 〈 {t}_{j} ◦ {y}^{*} 〉 - 〈 {t}_{i}^{*} ◦ {y}^{*} 〉 〈 {t}_{j} ◦ y 〉 \qquad [ Equation 4 ]$$

The given speckle field y=Tx=Σᵢ₌₁^{N} xᵢTeᵢ=Σᵢ₌₁^{N} and the near-orthogonal properties [symbol] tᵢ*∘tⱼ [symbol] ≈ [symbol] tᵢ*∘tᵢ [symbol] δᵢⱼ of the speckle field, we may rewrite the second term in equation as [symbol] xᵢxⱼ* [symbol] tᵢ*∘tᵢ [symbol] tⱼ*∘tⱼ [symbol] . Then, substituting Equation 4 into Equation 3, we have the following result.

$${Z}_{ij} = {x}_{i} {x}_{j}^{*} + \frac{〈 {t}_{i}^{*} ◦ {y}^{*} 〉 〈 {t}_{j} ◦ y 〉}{〈 {t}_{i}^{*} ◦ {t}_{i} 〉 〈 {t}_{j}^{*} ◦ {t}_{j} 〉} \qquad [ Equation 5 ]$$

The first term of Equation 5 is the projection matrix of the sample field XX^{†}, which has the information of the sample field as it is, and the second term represents another random matrix. Since the second term converges to zero as the oversampling ratio (r=M/N) increases, we may directly obtain the sample field x by obtaining the eigenvector of the SSM for large r. However, the large r will not occur because of the finite sampling number. We want to get as much information of the sample as possible from the same number of measurements (M); therefore, it is usually preferred to use as small a value of r as possible on average (e.g. r=14 in the reference).

For small r, an additional error-reducing algorithm has to be introduced because of the influence of the second term. Iterative algorithms are usually exploited by using the eigenvectors corresponding to the largest eigenvalue of the SSM as the initial estimate xᵢ′. We used AF. Note that the SSM initialization is similar (but not identical) to the spectral initialization proposed separately in Ref.

An additional technique was used to calculate the SSM. Due to the noise level of the SSM (second term in Equation 5), we may see that the high frequency signal was hardly obtained in the initial estimate xᵢ′. Based on these observations, we proceeded with SSM only in the low frequency region of the sample, which significantly reduced the computation time.

### Amplitude Flow

The initial estimate x₀′ for AF is computed as \hat{x}′ᵢ [symbol] , where \hat{x}′ᵢ=\hat{x}′ᵢ/∥\hat{x}′ᵢ∥ is the normalized eigenvector corresponding to the largest eigenvalue of the SSM, and <I> is the average of the measured speckle patterns,

$$τ = \frac{1}{N} tr ( {T}^{†} T )$$

is a scaling factor. Here the physical meaning of τ is the average transmission rate of our system. Since the transmission rate of our system is largely determined by the diffuser and hardly determined by the sample field, τᵢ^{†}tᵢ≈tⱼ^{†}tⱼ usually holds. Therefore, we simply estimated by taking the size of the first term of T^{†}Te₁.

The k-th AF iteration is calculated as follows.

$${x}_{k + 1}^{′} = {x}_{k}^{′} - \frac{μ}{τ} {T}^{†} ( {y}_{k}^{′} - {w}_{k} ) \qquad [ Equation 6 ]$$

Here, μ is the size of the step, xₖ′ is the sample field obtained when the k-th iteration is performed, and yₖ′=Txₖ′ is the corresponding speckle field in which the size is replaced with the size of the measured speckle. The j-th vector component of wₖ is w_{k,j}=\sqrt{Iⱼ}y_{k,j}/|y_{k,j}|. The step size μ determines the speed of convergence. We used μ=1 during the study. We stopped iterating when the standardized correlation and the previous solution converged to unity. It is \hat{x}′ₖ^{†}\hat{x}′ₖ₋₁>0.9999977, \hat{x}′ₖ=x′ₖ/∥x′ₖ∥ is normalized xₖ′. This convergence criterion was derived empirically in a mathematical context (see the MATLAB code in the supplemental material).

### Fourier-Transformation Based on TM Calculation

As mentioned, the results of FIGS. 3 and 6 have N=43,003 and M=778,414. The size of the corresponding TM is M×N=778,414×43,003, which occupies ˜270 GB of memory using complex single precision. Creating and handling matrices as large as this is a cumbersome and time consuming task. Since the magnitude of TM is proportional to N² for a fixed r, the limited memory of the computer may be a major limitation to the resolution of the FOV or the acquired sample field. Therefore, we will calculate TM as a series of operations based on paraxial approximation and Fourier transforms.

Assuming a point source in the light source, we have to find the propagated field at the axial distance z=L. The propagated field may be calculated as follows.

$$G ( x , y , L ) = \int {e}^{i 2 π ( ux + vy + wL )} dudv \qquad [ Equation 7 ]$$

Here, (x,y) are the lateral coordinates and (u,v,w) are the spatial frequencies of (x,y,z), respectively, u²+v²+w²=λ⁻² is satisfied. Near-axial approximation

$$w \approx {λ}^{- 1} - \frac{1}{2} λ ( {u}^{2} + {v}^{2} )$$

was applied, and the integral was calculated. Equation 7 becomes as follows.

$$G ( x , y , L ) = \frac{1}{iL λ} {e}^{i \frac{2 π}{λ} L} Q ( x , L ) Q ( y , L ) \qquad [ Equation 8 ]$$

$$Here , Q ( x , L ) = exp ( i π {x}^{2} / ( λ L ) )$$

is a quadratic phase function. Similar results may be obtained using the Rayleigh-Sommerfeld diffraction equation. After this we will ignore the y-axis.

Since we have wavelets from the point source, we may make the propagation operator of length L(PL) into a convolution form P_{L}[E](x)=∫E(x′)G(x−x′,L)dx′, where E(x) is an arbitrary field on the plane before propagation (z=0). Substituting [Equation 8] into this convolution, we may obtain the following equation.

$${P}_{L} [ E ] ( x ) = \frac{1}{iL λ} {e}^{i \frac{2 π}{λ} L} Q ( x , L ) \int E ( {x}^{′} ) Q ( {x}^{′} , L ) \text{?} {dx}^{′} \qquad [ Equation 9 ]$$

$$\text{?} \text{indicates text missing or illegible when filed}$$

Note that the integral in equation 9 is a Fourier transform of E(x)Q(x,L), which may be quickly calculated through a fast Fourier transform (FFT) algorithm. The transfer operator T may be obtained through two progress operators a transfer and function t_{d}(x)−T[E](x)=P_{L}_{₂}[t_{d}·P_{L}_{₁}[E]](x) of a diffuser. As we have seen, we used a GPU (GeForce GTX 1080 Ti, NVIDIA Corp.) to further accelerate the computation speed.

### Derivation of Resolution Limits

Recall that the spatial resolution of our system was defined as 1.22 L1λ/D_{d}. As a result, the limit value of the resolution of the diameter Da of a given diffuser is set to the minimum L₁ that may be used as long as the operating condition of the CSI is not violated. There are two key operating conditions for CSI: (i) the measured image should be a speckle pattern, and (ii) the oversampling ratio (r) should be greater than the minimum oversampling rate (rₘᵢn) for stable field acquisition.

Condition (i) is associated with Equation 4, and this is why we need a diffuser for CSI. However, even with a diffuser, this condition may be misaligned when L₁ is too small to allow the sample field to make a focal spot that is smaller than the feature size of the diffuser. More precisely, the spatial bandwidth of the sample field at the surface of the diffuser should be less than the modulation bandwidth (BW_{d}) of the diffuser. Dₛ/(L₁λ)<BW_{d}). This is because BW_{d} may be characterized by the maximum divergence angle (θ_{d}) of the diffuser (e.g., BW_{d}=2θ_{d}/λ), we determined the first condition of L₁.

$${L}_{1} > \frac{{D}_{s}}{2 {θ}_{d}} \qquad [ Equation 10 ]$$

In this study, we defined θ_{d} based on the far field diffraction pattern of the diffuser ((d) of FIG. 2). When we view the central circular region as the preserved effective angular deflection distribution of the diffuser, we get θ_{d}=1.22λ/Dₕ at the first zero of the sombrero function.

Condition (ii), r>rₘᵢₙ, is related to the restorative stability of CSI explored in previous studies. R is defined as M/N, where N and M are the number of spatial modes of the sample field and the speckle field, respectively. The rₘᵢₙ depends mostly on the noise level of the imaging system. It is empirically known that even for a noise-free system, rₘᵢₙ>4 is required for stable reconstruction. In this study, we conservatively set rₘᵢₙ=7, taking into account any substantial noise or errors. M and N may be quantified by calculating SBP. For example, the spatial diameter and the reciprocal grating diameter of the same field are Dₛ and D_{d}/(L₁λ). Thus, N is as follows.

$$N = \frac{π}{4} {D}_{s}^{2} \cdot \frac{π}{4} {( \frac{{D}_{d}}{{L}_{1} λ} )}^{2} \qquad [ Equation 11 ]$$

Similarly, M is as follows.

$$M = \frac{π}{4} {D}_{spk}^{2} \cdot \frac{π}{4} {( \frac{{D}_{d}}{{L}_{2} λ} )}^{2} \qquad [ Equation 12 ]$$

Here, Dₛₚₖ is the diameter of the speckle pattern in the detector plane.

Since we have considered the minimum boundary of L₁, the synthetic aperture zone should be considered to accurately define the oversampling ratio (FIG. 5). When the diffraction angle of the sample exceeds θ_{d}, the diffuser may not collect all sample diffractions into a single point (FIG. 5, insertion diagram). In other words, at a point on the detector plane, the entire diameter of the diffuser is not visible, but only parts. When completely different parts are visible at two points on the diffuser plane, these are points that are no longer associated with one another. Therefore, a diffuser should be viewed as a combination of several sub-diffusers rather than as a single unit. In order to calculate Equations 11 and 12 for the sub-diffusers, the diameter of the sub-diffuser (D_{d}^{sub}) and the effective diameter of the scaling pattern in the detail-diffusion (Dₛₚₖ^{sub}) should first be defined.

D_{d}^{sub} may be calculated from the maximum diameter of the diffuser seen at one point of the detector (FIG. 5, insertion diagram). A momentum (or angle) conservation equation may be built, which is as follows.

$$\frac{( {D}_{d}^{sub} - {D}_{s} )}{2 {L}_{1}} + \frac{{D}_{d}^{sub}}{2 {L}_{2}} = {θ}_{d} \qquad [ Equation 13 ]$$

First and second terms on the left-hand side of Equation 13 are the divergence angle starting from the boundary of the FOV of the sample before entering the diffuser and the convergence angle that converges to a point on the detector after passing through the diffuser, respectively. The sum of the two angles is θ_{d} at the largest possible diameter D_{d}^{sub} of the sub-diffuser. Solving the Equation 13 with respect to D_{d}^{sub}, we may define the diameter of the sub-diffusor for given variables D_{S} and L₁, and L₂.

$${D}_{d}^{sub} = \frac{{L}_{2}}{{L}_{1} + {L}_{2}} ( {D}_{s} + 2 {L}_{1} {θ}_{d} ) \qquad [ Equation 14 ]$$

When D_{d}^{sub}<D_{d}, this is a synthetic hole region, and the sub-diffusers should be considered; otherwise (D_{d}^{sub}>D_{d}), this is a single aperture zone and equations 13 and 14 are invalidated, and the diffuser is recognized as one (FIG. 5). Note that the dotted line in FIG. 5 is when D_{d}^{sub}=D_{d}, which is the boundary line of the two regions.

Dₛₚₖ^{sub} may be estimated from the projection of the sub-diffusers onto the detector plane.

$${D}_{spk}^{sub} = ( 1 + \frac{{L}_{2}}{{L}_{1}} ) {D}_{d}^{sub} \qquad [ Equation 15 ]$$

In a single sub-diffuser, Equation 15 may appear non-formal because it completely ignores diffraction from the diffuser. However, we believe that the diffractive FOV superimposed between orthogonal sub-diffusers is a mutual effect and becomes insignificant when determining the effective FOV. Subtracting Equations 14 and 15, Equations 11 and 12, we obtain the oversampling ratio of the sub-diffusers, r=(1+2L₁θ_{d}/Dₛ)² and condition (ii) is as following.

$${L}_{1} > ( \sqrt{{γ}_{min}} - 1 ) \frac{{D}_{s}}{2 {θ}_{d}} \qquad [ Equation 16 ]$$

When rₘᵢₙ≥4, specify that Equation 16 includes Equation 10. Since rₘᵢₙ≥4 is empirically known to be an oversampling condition in a noisy situation, we may conclude that Equation 16 alone determines the minimum bound of L₁. The resolution limit (Equation 1) is obtained by replacing Equation 16 with the definition of spatial resolution (δx=1.22 L₁λ/D_{d}) and θ_{d}=1.222/Dₕ.

Criteria for Possible L₁ and L₂

In FIG. 5, there are three criteria associated with oversampling conditions (purple line), sampling resolution (blue line), and detector size (red line) for possible L₁ and L₂. The purple line derived from the oversampling condition is detailed in the derivation of the resolution limit part of the method. As shown in Equation 16, this provides the minimum bound of L₁. Unlike the other two conditions, this is a fundamental condition that is independent of realistic sampling conditions.

The blue line in FIG. 5 was introduced to keep the speckle grain size larger than the realistic sampling resolution (p). More precisely, the spatial bandwidth of the speckle field above the detector plane should be less than the bandwidth of the detector, D_{d}/(L₂λ)<1/p, which provides the minimum bound of L₂.

$${L}_{2} > \frac{p}{λ} {D}_{d} \qquad [ Equation 17 ]$$

In a single aperture zone, this criterion is independent of L₁ [symbol] as shown by the vertical line in FIG. 5. In the combination aperture zone, the diffuser diameter (D_{d}) in Equation 17 should be replaced by the sub-diffusor diameter (D_{d}^{sub}), which is a function of L₁ and L₂ defined in Equation 14. Therefore, this condition is a function of both L₁ and L₂ in the combination aperture zone (FIG. 5). p may be determined by the size of the detector pixel or the resolution limit of the detection system. In this study, we used the two camera pixel sizes of the scintillator (p=1.3 μm, considered 10 times magnification). We set p to two pixels (rather than one) in order to obtain the total bandwidth of the intensity speckle pattern, which is twice the speckle field bandwidth in the reciprocal space. This is particularly important in the image pre-work phase.

The red line in FIG. 5 has been introduced to meet the oversampling condition in a given detector with a defined sensor size. When the underlying condition (purple line of FIG. 5) is met, the oversampling condition (r>rₘᵢₙ) may be violated when the actual detector size (F) is too large. Thus, we have to introduce one more substantive condition in addition.

$$F > {D}_{spk} \qquad [ Equation 18 ]$$

Here, Dₛₚₖ is the diameter of the speckle pattern on the detector plate. This is a natural condition since the speckle pattern generated outside the detector may not be obtained. In a single aperture zone, the oversampling condition may be simply defined by Equation 11 and Equation 12.

$$γ = {( \frac{{D}_{spk}}{{D}_{s}} \frac{{L}_{1}}{{L}_{2}} )}^{2} > {γ}_{min} \qquad [ Equation 19 ]$$

Substituting the Equation 18 into the Equation 19 gives the following equation.

$$\frac{F}{{D}_{s}} \frac{{L}_{1}}{\sqrt{{γ}_{min}}} > {L}_{2} \qquad [ Equation 20 ]$$

This provides the maximum bound of L₂, as indicated in FIG. 5. In the combination aperture zone, the oversampling condition of the inner sub-diffusers has already been considered in Equation 16, but the oversampling condition of the outermost detail hole has to be considered separately since there are no sub-diffusers orthogonal to one side. The detector diameter required for internal sub-diffusers is Dₛₚₖ^{sub} multiplied by the number of sub-diffusers (D_{d}−D_{d}^{sub})/D_{d}^{sub} at the centerline of the diffuser, which is (1+L₂/L₁)(D_{d}−D_{d}^{sub}) according to Equation 15. When we define D_{d}^{out} as the diameter of the speckle pattern for which the outermost sub-diffuser is needed, then Equation 18 in the combination aperture zone is as follows.

$$F > {D}_{d}^{out} + ( 1 + \frac{{L}_{2}}{{L}_{1}} ) ( {D}_{d} - {D}_{s}^{sub} ) \qquad [ Equation 21 ]$$

As D_{d}^{sub}→D_{d}, Equation 21 should converge to Equation 20, D_{d}^{out}=\sqrt{Yₘᵢₙ}DₛL₂/L₁ may be derived. Since D_{d}^{sub} is also a function of L₁ and L₂ (Equation 14), Equation 21 is a nonlinear curve in the L₁-L₂ plane as shown in FIG. 5. In this study, F was defined as the sensor size of the camera (2048×2048), which is 1331 μm on one side, taking into account the 10 times microscope magnification.

### Speckle-Correlation Scattering Matrix (SSM)

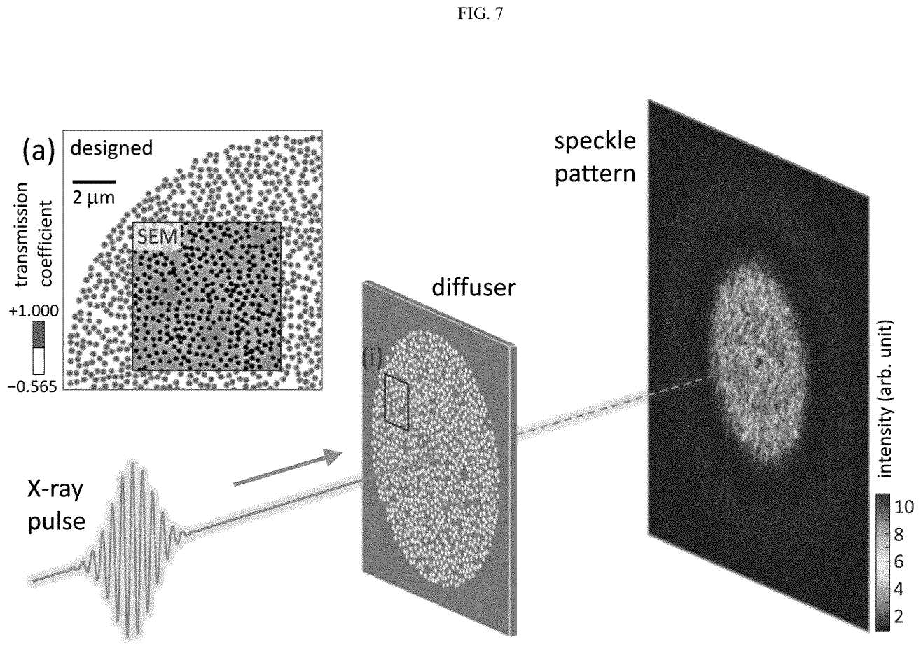

We propose a useful single-shot field characterization technique using SSM. SSM is a recently proposed field acquisition technique that may import incident field information having complex values from an intensity speckle pattern using the pseudo-random stochastic nature of the speckle. To utilize SSM, we converted any incident field into a speckle pattern by installing an X-ray diffuser in front of the detector as indicated in FIG. 7. Successful pulse characterization was tested with various experimental combinations of Pohang Accelerator Laboratory XFEL (PAL-XFEL).

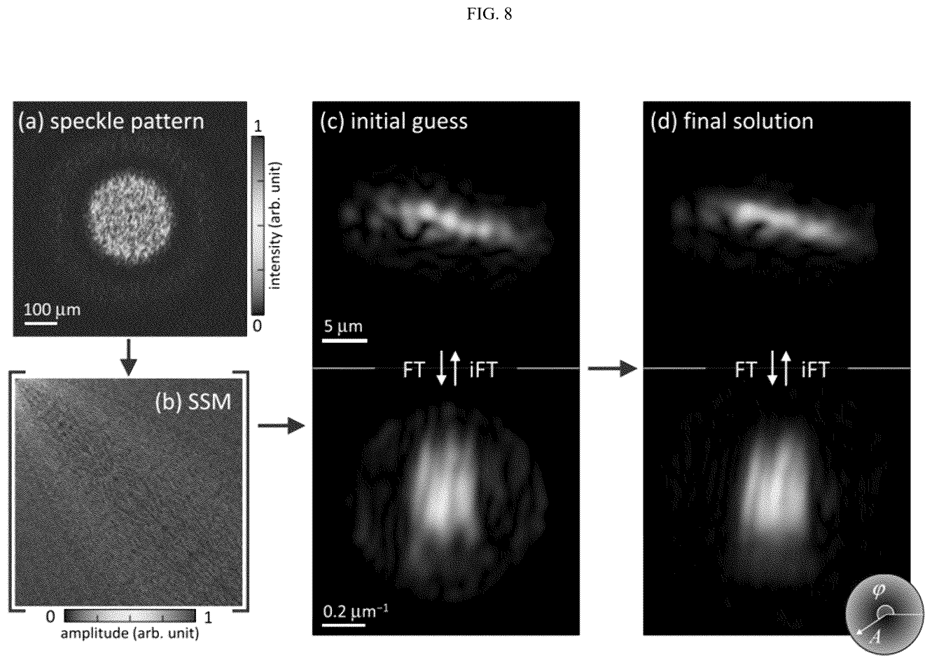

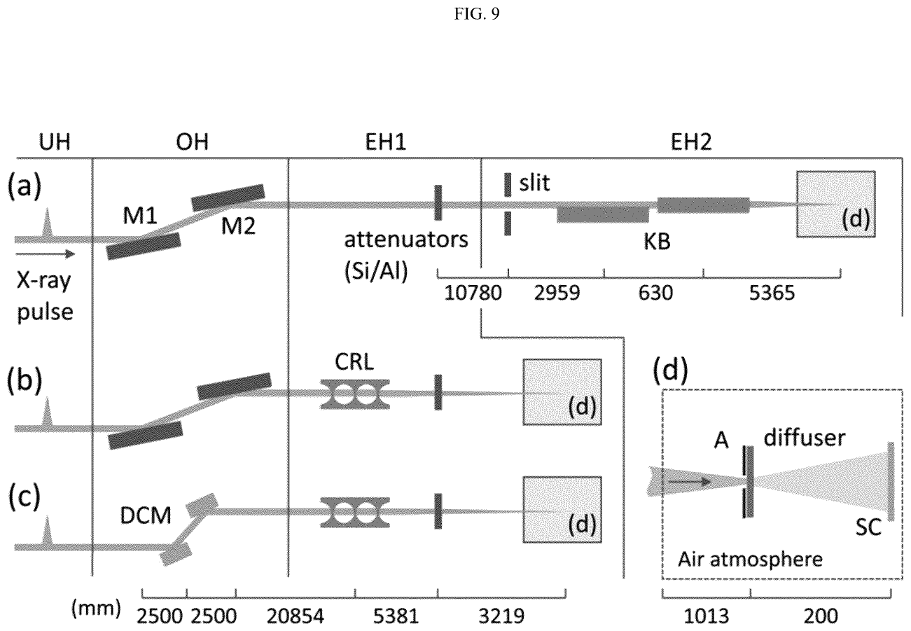

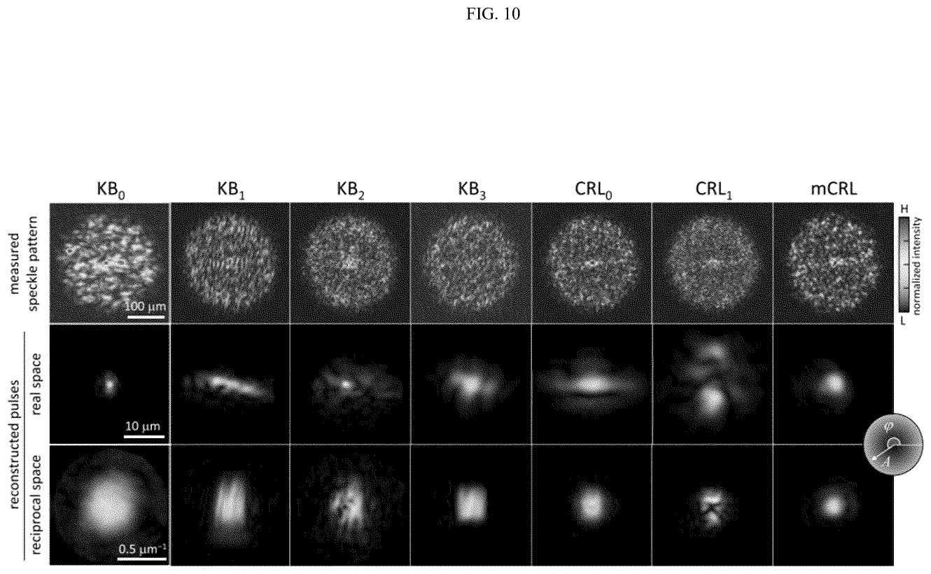

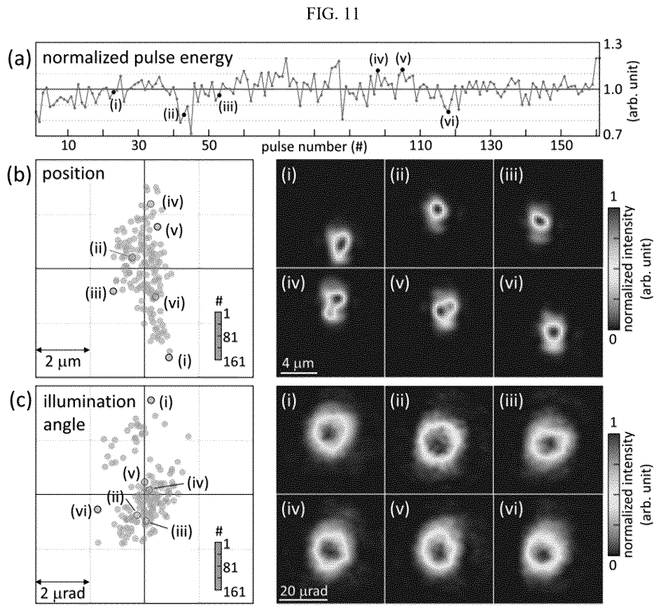

Hereinafter, it is specifically described in connection with SSM. FIG. 7 is a diagram illustrating a field characterization setting for a speckle-correlation scattering matrix (SSM) according to the present disclosure. FIG. 8 is a diagram illustrating a field acquisition order for an SSM according to the present disclosure. FIG. 9 is a diagram illustrating an experimental setup for an SSM according to the present disclosure. FIG. 10 is a diagram illustrating field characterization experiment results for an SSM according to the present disclosure. FIG. 11 is a diagram illustrating inter-pulse variation for an SSM according to the present disclosure.

### 1. Principle

### Designed X-Ray Diffuser

Designed diffusers are similar to disorder-engineered metasurfaces in fluorescence imaging, geometric phase diffusers in optical microscopes, and modulators in coherent x-ray modulation imaging (CMI).

The X-ray diffuser was made of a tungsten film on a silicon nitride plate. This diffuser consists of holes that are pseudorandomly positioned and etched in the diameter (25 μm) of the diffuser, as shown in (a) of FIG. 7. The locations of the pseudo-random holes were created by numerical free diffusion of the holes within the boundary. The diameter of the hole (300 nm) and the minimum gap between the hole and the hole (30 nm) are determined according to the manufacturing reproducibility of the manufacturer (ZonePlates Ltd., UK). The number of holes (2507) and the thickness of the tungsten film (1100 nm) are determined by maximizing the diffraction efficiency of the diffuser at a given X-ray (5.456 keV). The transmission rate of the tungsten region is designed to be −0.565, which is 32% (=0.5652) transmission rate when πₚₕₐₛₑ delay occurs. The fabricated hole diameters and positions were verified by lobe size and speckle shape of the observed diffraction pattern, respectively (FIG. 7).

We calculated the transmission matrix through a given hole size, the position of the hole, and the propagation length after passing through the diffuser. Potential experimental errors in diffuser roll angle and propagation length (200 mm) were fine-tuned numerically by maximizing field acquisition reliability. It is noted herein that a direct incident field is not available for a given TM due to phase loss during speckle pattern acquisition. This should not be confused with a spatially asymmetric system having a positive and a real TM.

### Speckle-Correlation Scattering Matrix (SSM)

SSM is a matrix calculated from the intensity photographs and the TM of the optical system. Since the principles of SSM have been fully addressed in previous studies and reviews, we will not address all the detailed equations here. Instead, we would like to introduce two key themes of SSM: oversampling and pseudo-randomness.

In the SSM technique, oversampling occurs by the diffuser, as indicated in FIG. 7. The diffuser creates numerous speckle grains in the detector plane and augments the obtainable independent sampling points. In terms of oversampling, this is similar to tycography, where an oversampling solution was introduced instead of sample scanning. Therefore, the iterative field acquisition algorithm used for diffractive imaging may be applied as tested in CMI.

However, although the uniqueness of the solution is ensured through oversampling, this does not imply convergence of the iterative algorithm. This is important in a situational problem which, as is generally known, is a deterministic polynomial time (NP-hard) problem. The global convergence of the field search will largely depend on the topography of the loss function, the initial point and the algorithm used. This is because their loss function is non-linear, non-convex and has many stop points. This is fundamental to the possibility of sample dependent phase recovery in CDI, CMI, and even optical imaging.

An innovation of SSM is that it leverages the pseudorandomness of speckle patterns to provide a direct and non-repetitive approach to global solutions. The SSM may be interpreted as a coherence matrix of the incoming field through Wick's (or Isserlis') theorem of Gaussian random number vectors. The solution is retrieved by taking the eigenvector that gives the largest eigenvalue of the SSM. In general, the fidelity of the SSM is related to the oversampling ratio and the actual noise level, so an additional iterative algorithm may be needed to minimize the error.

Our field acquisition technique is indicated in FIG. 8. This proceeds in the following order: (i) speckle pattern measurement ((a) of FIG. 8); (ii) SSM measurement from the measured image ((b) of FIG. 8); (iii) initial estimate from the eigenvalue decomposition of the SSM ((c) of FIG. 8); and (iv) convergence from the initial estimate to the nearest solution through amplitude flow ((d) of FIG. 8). Detailed principles and equations are in recent work on visible light sharing the same field recovery flow.

### 2. Results and Discussion

### Experimental Construction

We demonstrated the idea in various settings in the experimental hutches of the hard X-ray beamlines (EH1 and EH2) of the PAL-XFEL. This is to demonstrate its flexibility. X-ray pulses of quantum energy centered at 5.456 keV were generated in the undulator hall (UH) throughout the experiment. First, in the experiment conducted in EH2, a Kirkpatrick-Bacz (KB) mirror system was used as the focusing optics, as shown in (a) of FIG. 9. The vertical and horizontal focus mirrors (VFM and HFM) have focal lengths of 5.995 m and 5.365 m, respectively. Then, in EH1, as shown in (b) of FIG. 9, a compound refractive lens (CRL) was used as focusing optics. The CRL consists of four beryllium lenses with an effective focal length of 8.2 m. Finally, the offset mirror of the optical barn (OH) was bypassed and the coloring effect of the CRL was investigated using a double crystal monochromator (DCM) as shown in (c) of FIG. 9. Detailed distances between optical components are provided in FIG. 9.

Based on the three setups shown in FIG. 9, we characterized the X-ray pulses in seven different configurations as summarized in Table 1. Configurations KB₀, CRL₀, and mCRL represent the normal conditions of the settings in (a), (b) and (c) of FIGS. 9, respectively. Other configurations are abnormal conditions, with alignment errors (KB₁, KB₂, and KB₃), focus deviations (KB₂ and CRL₁), or additional filtering (KB₃) introduced. As indicated in Table 1, an absorber (silicon or aluminum) of appropriate thickness was used to prevent radiation damage to the diffuser.

TABLE 1

| | Setup | | | | |
|---|---|---|---|---|---|
| Identifier | ( [symbol] 9) | Attenuator | | ΔE/E | Remarks |
| KB₀ | a | Si 100 | μm | 0.3% | Normal condition |
| KB₁ | a | Si 50 | μm | 0.3% | Not aligned KB |
| KB₂ | a | Al 53 | μm | 0.3% | Aberrated, not |
| | | | | | aligned KB |
| KB₃ | a | Si 50 | μm | 0.3% | Reduced slit, not |
| | | | | | aligned KB |
| CRL₀ | b | Si 50 | μm | 0.3% | Normal condition |
| CRL₁ | b | Al 45 | μm | 0.3% | Aberrated |

| | | | | |
|---|---|---|---|---|
| mCRL | c | No attenuator | <0.01% | Normal condition |

During the experiment, a pink beam (1E/E=0.3%) was used in all experiments except for the mCRL configuration. In the mCRL configuration, a monochromatic beam utilizing a single frequency (1E/E<0.01%) was used. Despite the difference in spectral bandwidth, both the pink and monochromatic beams are much narrower than the spectral resolution of the diffuser used (1E/E=5%), so both beams may be considered as a single frequency in our measurements. The potential pulse-to-pulse maximum frequency variation is not expected to similarly affect the measurement.

In all configurations, a diffuser-based field characterization unit is installed near the focal plane ((d) of FIG. 9). This unit consists of an aperture, a diffuser and an image sensor. The aperture blocks X-rays that exit out of the diffuser. It is made of a gold film with a thickness of 50 μm and has the same diameter (25 μm) as the diffuser. The aperture is an optional component when the pulse does not exceed the diffuser diameter, but we have found that it greatly improves the robustness of the system, especially in situations where there is misalignment or deviation. The image sensor used was Tb:LSO (Tb³⁺:Lu2SiO₅) scintillator equipped with an optical microscope (×10) and a sCMOS camera (6.5 μm, C11440-22C, Hamamatsu Photonics K.K.). The effective pixel size is 650 nm, and the maximum speckle particle size is 2.2 μm based on the aperture diameter and the diffuser-scintillator distance (200 mm). The camera shutter was synchronized with the pulse generation triggers (10 Hz) to ensure that the acquired image was generated by a single pulse.

We have found that radiation damage of the diffuser may be a real problem. This study mitigated this problem by introducing additional absorbers and preparing 100 identical diffusers on the same substrate. The diffuser was replaced when radiation damage occurred. For longer durability, however, it is recommended to arrange the diffuser out of the focal plane, which requires a diffuser with a large diameter. When the diffuser may be made of a radiation-damaging material such as diamond, it is expected that semi-permanent use of the diffuser is also possible.

### Pulse Characterization Results

The measured speckle pattern is shown in the first row of FIG. 10. The diffraction efficiency of the diffuser used through the intensity fraction of the central unmodulated term was estimated to be at least 90% as intended in the diffuser design. We excluded the remaining unmodulated terms from the field search order by introducing a numerical beam aperture of 62.5 μm diameter. Low signals were observed, especially in the KB₀ and KB₃ configurations. The KB₀ configuration required a thicker (100 μm) silicone absorber to prevent diffuser damage due to the denser focus. The KB₃ configuration resulted in low fluence due to the reduced slit size.

The corresponding field search results are shown in the second and third rows of FIG. 10 in real and reciprocal grating (or Fourier space) space, respectively. The field retrieved via numerical propagation was first brought to the focal plane, which corresponds to the secondary phase compensation in the reciprocal space. The results were performed to compare under the same conditions. The linear phase ramp in real and reciprocal space was then removed, which corresponds to the beam center alignment in reciprocal and real space. The single field search operation took 4-5 seconds using MATLAB software using a single GPU (GeForce RTX 3090, NVIDIA Corp.).

In the KB0 configuration ((a) of FIG. 9), dense foci with FWHM of 1.24 and 1.55 μm for the horizontal and vertical directions, respectively, were observed in the experiments performed. The measured values are smaller than those previously reported in PAL-XFEL, which were 1.94 and 2.08 μm for the horizontal and vertical directions, respectively. The previously used wire scan values may be an overestimate of the actual roughness of the wire and the positional variation between pulses. Minor errors in the VFM alignment may be found from the non-constant phase running along the longitudinal direction in the reciprocal space.

An asymmetric focus is observed in the CRL₀ configuration ((b) of FIG. 9). The detected focus shows a FWHM of 5.90 μm in the transverse direction and 2.73 μm in the longitudinal direction. The size in the reciprocal space (i.e., the spatial bandwidth) is smaller than that of the KB mirror system, indicating a smaller numerical hole (NA).

In the mCRL configuration ((c) of FIG. 9), we observe a more symmetric focus than in the CRL0 configuration. The detected focus shows a FWHM of 2.92 μm in the horizontal direction and 3.23 μm in the vertical direction. By comparing CRL₀ with mCRL, it may be inferred that the asymmetric focus in the CRL₀ configuration may be induced due to some alignment error in the transverse position of the CRL. Due to the color characteristics of the CRL, the position offset causes a spectroscopic effect, such as a prism, extending the focus in the offset direction along the pink beam.

The KB₁ configuration is based on KB0 but before the fine alignment of the KB mirror system. We observed a significant deterioration in the size, shape and wavefront of the focal spot. From the identified hole reduction and strong phase change in the transverse direction in the reciprocal space, we may assume that the non-mirror surface of the HFM has been applied.

The KB₂ and CRL₁ configurations are based on KB₁ and CRL₀, respectively, but with aluminum foil as the attenuator instead of silicone. A significant anomaly was introduced due to the non-uniform surface of the aluminum foil, which could be observed as a phase change in reciprocal space. These results indicate that our method is robust even for complex shaped incident fields.

The KB₃ configuration is based on KB₁ but the slit in front of the KB mirror system has been reduced. The reduced slit may be observed directly with a rectangular aperture in the reciprocal space. The phase values in the rectangular window are largely preserved. This result is in good agreement with expectations and indicates the fidelity of our field characterization method.

### Spatial Resolution

Compared to the recovery viewing angle (FOV), this is a constant determined by the diffuser diameter (25 μm), and the recovery bandwidth (B) is an adjustable variable determined by the numerically generated TM. Nevertheless, B may not be set to an infinitely large value to meet a sufficient oversampling ratio. The oversampling ratio (λ) of our measurement may be expressed by the space-bandwidth product (SBP) operation as Equation 22.

$$γ = {( 1 + \frac{{B}_{d}}{B} )}^{2} \qquad [ Equation 22 ]$$

Here, B_{d} is the spatial bandwidth of the diffuser. According to Equation 22, increasing B is inefficient for oversampling and noise adjustment. Thus, we set B adaptively to the NA of the focus elements used to maximize the recovery fidelity. Reconstruction bandwidths of 1.22 and 0.813 μm⁻¹ were used for high NA (KO₀, KB₁, and KB₂) and low NA (KB₃, CRL₀, CRL₁, and mCRL), respectively. Based on the Rayleigt condition (1.22/B), the corresponding spatial resolution is 1.0 and 1.5 μm, respectively.

The spatial resolution limit is also related to the oversampling ratio. Previous studies have shown that the empirically known condition for robust field reconstruction even in noisy situations is r≥4. We find that Ba is the upper limit value of the achievable bandwidth (B≤B_{d}) by applying a low limit to Equation 22. Based on the central circular plateau of the speckle pattern of FIG. 10, Ba may be estimated to be 2.44/Dₕ, the first zero of the sombrero function. Here, Dₕ is the hole diameter. The theoretical resolution limit (1.22/B_{d}) is then Dₕ/2, which is 150 nm in this study. It should be noted that depending on the noise level of the experiment, the actual resolution limit is larger than the theoretical value.

### Inter-Pulse Variation

Based on the SSM-based pulse characterization results, we investigated the pulse-to-pulse variation of PAL-XFEL. For all configurations in Table 1, variations in pulse intensity, position, irradiation angle and shape were analyzed. The results obtained in the KB₀ configuration are representatively shown in FIG. 11. The results summarizing the standard deviation of variation (SD) are presented in Table 2.

TABLE 2

| | Number | Normal- | | | Illumination | |
|---|---|---|---|---|---|---|
| | of | ized | Position (μm) | | Angle (μrad) | |
| Config. | Pulses | Intensity | Horizontal | Vertical | Horizontal | Vertical |
| KB₀ | 161 | 0.078 | 0.49 | 1.30 | 0.63 | 1.15 |
| KB₁ | 600 | 0.091 | 0.33 | 0.92 | 0.24 | 0.36 |
| KB₂ | 581 | 0.103 | 0.36 | 0.81 | 0.24 | 0.37 |
| KB₃ | 499 | 0.082 | 0.29 | 0.80 | 0.33 | 0.12 |
| CRL₀ | 1000 | 0.087 | 1.43 | 1.01 | 0.79 | 0.23 |
| CRL₁ | 1000 | 0.098 | 0.72 | 1.20 | 0.65 | 0.36 |
| mCRL | 102 | 0.510 | 0.92 | 2.09 | 0.48 | 0.51 |

*All fluctuation values are presented in standard deviations.

As shown in Table 2, a non-uniform number of pulses was used between configurations for variation analysis. This is because we have excluded speckle patterns in the diffuser that were damaged due to radiation prior to the processing step for reliability. Therefore, relatively small pulses were used for configurations with optimized focus (KB₀ and mCRL).

The pulse intensity normalized by the sum of the intensities of the measured speckle patterns was quantified ((a) of FIG. 11). The SD of the measured normalized pulse energy is from 0.078 to 0.103 and 0.51 for the pink and mono beams, respectively, which is similar to the values previously reported in PAL-XFEL (0.106 and 0.42).

The pulse position and irradiation angle were quantized to the center intensity of the pulses retrieved in real and reciprocal space, respectively ((b) and (c) of FIG. 11). Similar variation results were seen between configurations sharing the same optical setup.

The position of the pulse and the irradiation angle were quantified by the center-of-intensity obtained in real space and reciprocal space, respectively ((b) and (c) of FIG. 11). Similar variations were found between settings sharing the same optical setting in FIG. 9.

For pulse positions, asymmetric fluctuating pulse positions are generally captured. The KB mirror based settings ((a) of FIG. 9; KB₀, KB₁, KB₂, and KB₃) show relatively low variation (0.29-0.49 μm) in the transverse direction, while similar variation (0.80-1.3 μm) in longitudinal direction. The mCRL settings show a relatively larger variation (2.09 μm) in the longitudinal direction. The overall measurement variation levels (14 μm and 6.4 μm, respectively) are significantly lower than those measured on an X-ray pump probe end station using 9 keV on a Linac Coherent Light Source.

Asymmetric variations with respect to the pulse irradiation angle are generally observed. We have found that the variation is not completely stochastic. For example, the first 1020 pulses in the KB₀ configuration consistently exhibit significantly higher illumination angles. In addition to the sudden change in KB₀, the KB-mirror based configuration shows a relatively low variation (0.24-0.33 urad) in the horizontal direction and a similar variation (0.12-0.36 urad) for the vertical direction. In KB₃, it may be observed that the vertical irradiation angle variation is significantly reduced (0.12 urad).

Intensity images of the selected six pulses of the KB₀ configuration were displayed both in real space and in reciprocal space to show the pulse shape variation (FIG. 11). As may be seen in pulses (iv) and (v) of FIG. 11, significant focal shape changes are observed. This beam shape change is expected to result from the inherent phase profile variation of the SASE pulses, as that level of change is not observed in the reciprocal space.

### 3. Conclusion

We proposed and demonstrated an SSM-based single pulse characterization method for XFEL. By introducing a pulse characterization unit consisting of an aperture, a diffuser and an imaging sensor, we were able to successfully obtain intensity, position, shape and phase information of individual SASE pulses in a single imaging. The substantial robustness of our method was verified by pulse characterization results in various experimental configurations. This diversity is based on the general field reconstruction capability of the SSM, which does not depend on prior constraints or approximations. Pulse variations in intensity, position, irradiation angle, and shape were explored based on pulse-to-pulse characterization.

Although we have focused on SPI in the introduction for brevity, accurate field characterization of XFEL pulses is important in most interference-based XFEL experiments. For example, X-ray photon correlation spectroscopy and X-ray speckle visibility spectroscopy practically measure the remote area diffraction of a synthesized sample with the reciprocal space of the incident field. Thus, the information of the inter-pulse incident field will help to interpret the incident field from the measured values and obtain pure data extracted from the sample. We believe that simultaneous incident field characterization is also possible by introducing additional settings, such as introducing parasitic geometry.

We believe that our technique may be used as a sample pulse characterization tool for XFEL. Real-time pulse characterization will be fully possible through additional hardware and software optimizations. This will aid in fine alignment of the optical instruments. Furthermore, since our field characterization technique measures the speckle pattern, other speckle-based pulse characterization techniques may be repeated without difficulty. For example, the transverse coherence of pulses may be characterized based on a speckle pattern.

In the following, a method and a system for single-shot field characterization using the SSM described above is described.

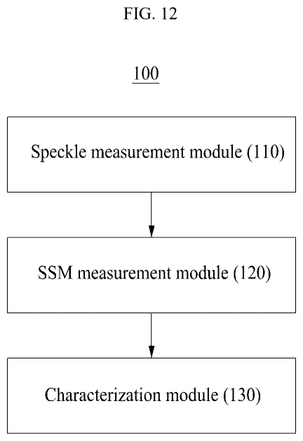

FIG. 12 illustrates a computer system 100 for single-shot field characterization using SSM according to the present disclosure.

Referring to FIG. 12, a computer system 100 may include a speckle measurement module 110, an SSM measurement module 120, and a characterization module 130. In some embodiments, the computer system 100 may be implemented within a single device. In other embodiments, the computer system 100 may be implemented as at least two devices. That is, the speckle measurement module 110, the SSM measurement module 120, and the characterization module 130 may be distributedly disposed in at least two apparatuses.

The speckle measurement module 110 may be configured to measure a speckle pattern for an incident field of an X-ray pulse. At this time, the speckle measurement module may measure the speckle pattern by converting the incident field into a speckle pattern through oversampling of the diffuser. The diffuser may include a plurality of holes that implement pseudo-randomness. The speckle pattern may consist of far-field diffraction of the holes.

The SSM measurement module 120 may be configured to measure a speckle-correlation scattering matrix representing complex value information of the incident field from the speckle pattern. At this time, the SSM measurement module may measure the speckle-correlation scattering matrix from the speckle pattern by using the transmission matrix calculated through the transfer function of the diffuser. The transmission matrix may be calculated from the size of the holes, the position of the holes, and the free propagation length before and the propagation length after the diffuser.

The characterization module 130 may estimate an estimate from the eigenvalue decomposition of the speckle-correlation scattering matrix. Here, the characteristic may include at least one of intensity, position, shape, or phase information of the X-ray pulse. And, the characterization module 130 may be configured to derive a final solution from the estimate through the amplitude flow.

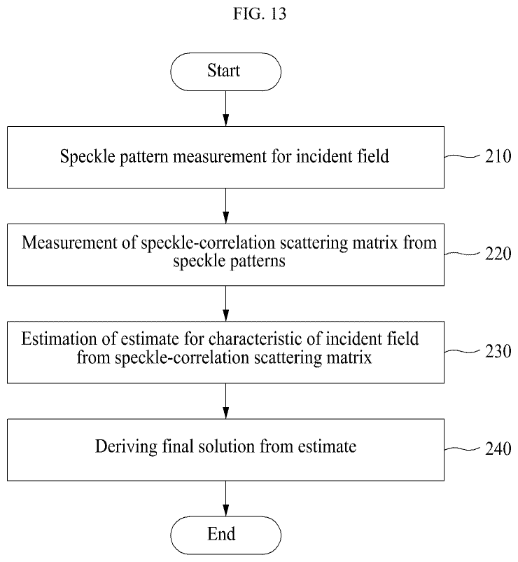

FIG. 13 illustrates a method of a computer system 100 for single-shot field characterization using SSM according to the present disclosure.

Referring to FIG. 13, in a step 210, the speckle measurement module 110 may be configured to measure a speckle pattern for an incident field of an X-ray pulse. The speckle measurement module may then measure the speckle pattern by converting the incident field into a speckle pattern through oversampling of the diffuser. The diffuser may include a plurality of holes that implement pseudo-randomness. The speckle pattern may consist of far-field diffraction of the holes. This may ensure oversampling and pseudo-randomness for speckle.

Next, in a step 220, the SSM measurement module 120 may be configured to measure a speckle-correlation scattering matrix representing complex value information of the incident field from the speckle pattern. At this time, the SSM measurement module may measure the speckle-correlation scattering matrix from the speckle pattern by using a transmission matrix calculated through the transfer function of the diffuser. The transmission matrix may be calculated from the size of the holes, the position of the holes, and the free propagation length before and the propagation length after the diffuser.

In a step 230, the characterization module 130 may estimate an estimate from the eigenvalue decomposition of the speckle-correlation scattering matrix. Here, the characteristic may include at least one of intensity, position, shape, or phase information of the X-ray pulse. The characterization module 130 may then estimate the eigenvectors corresponding to the largest eigenvalue of the speckle-correlation scattering matrix as initial estimates.

Next, in a step 240, the characterization module 130 may be configured to derive a final solution from the estimate through an amplitude flow. The characterization module 130 may then use the amplitude flow for error reduction. The final solution may represent the closest solution that converges from the estimate.

According to the present disclosure, successful field reconstruction is possible using a speckle-correlation scattering matrix. That is, by measuring a speckle-correlation scattering matrix representing complex value information of an incident field from a speckle pattern for the incident field, a characteristic for the incident field may be obtained through the speckle-correlation scattering matrix. This may increase the accuracy of the single-shot and increase its usability.

It is to be understood that the various embodiments of this document, and the terminology used therein, are not intended to limit the technology described herein to particular embodiments, but are to encompass various modifications, equivalents, and/or alternatives of those embodiments. In connection with the description of the figures, like reference numerals may be used for like components. The singular forms “a,” “an,” and “the” may include the plural forms as well, unless the context clearly indicates otherwise. In this document, expressions such as “A or B”, “at least one of A and/or B”, “A, B, or C” or “at least one A, B, and/or C” may include all possible combinations of the listed items together. Expressions such as “first”, “second”, “firstly”, or “secondly” may modify the corresponding components regardless of order or importance, and are only used to distinguish one component from another component and do not limit the corresponding components. When an element is referred to as being “(physically or functionally) connected” or “accessed” to another element, the element may be directly connected to the other element or connected through another element, e.g., a third element.

According to various embodiments, each component of the described components may include one or more entities. According to various embodiments, one or more components or operations of those components described above may be omitted, or one or more other components or operations may be added. Alternatively or additionally, a plurality of components may be integrated into one component. In such a case, the integrated component may perform one or more functions of each of the plurality of components the same as or similar to those performed by that component of the plurality of component prior to integration.

What is claimed is:

1. A method of single-shot field characterization using a speckle-correlation scattering matrix of a computer system, comprising:
a step of measuring a speckle pattern for an incident field of an X-ray pulse;
a step of measuring a speckle-correlation scattering matrix representing complex value information of the incident field from the speckle pattern;
a step of estimating an estimate for a characteristic of the incident field from eigenvalue decomposition of the speckle-correlation scattering matrix; and
a step of deriving a final solution from the estimate through an amplitude flow.

2. The method of claim 1,
wherein the step of measuring a speckle pattern comprises:
a step of measuring the speckle pattern by converting the incident field into the speckle patterns through oversampling of a diffuser.

3. The method of claim 2,
wherein the step of measuring a speckle-correlation scattering matrix comprises:
a step of measuring the speckle-correlation scattering matrix from the speckle pattern using a transmission matrix calculated through a transfer function of the diffuser.

4. The method of claim 3,
wherein the diffuser comprises a plurality of holes implementing pseudorandomness, and
the speckle pattern consists of far-field diffraction of the holes.

5. The method of claim 4,
wherein the transmission matrix is calculated from the size of the holes, the position of the holes, and the free propagation length before the diffuser and the propagation length after the diffuser.

6. The method of claim 1,
wherein the characteristic comprises at least one of intensity, position, shape, or phase information of the X-ray pulse.

7. A system for single-shot field characterization using a speckle-correlation scattering matrix, comprising:
a speckle measurement module configured to measure a speckle pattern for an incident field of an X-ray pulse;
an SSM measurement module configured to measure a speckle-correlation scattering matrix representing complex value information of the incident field from the speckle pattern; and
a characterization module configured to estimate an estimate from eigenvalue decomposition of the speckle-correlation scattering matrix and to derive a final solution from the estimate through an amplitude flow.

8. The system of claim 7,
wherein the speckle measurement module is configured to measure the speckle pattern by converting the incident field into the speckle patterns through oversampling of a diffuser.

9. The system of claim 8,
wherein the SSM measurement module is configured to measure the speckle-correlation scattering matrix from the speckle pattern using a transmission matrix calculated through a transfer function of the diffuser.

10. The system of claim 9,
wherein the diffuser comprises a plurality of holes implementing pseudorandomness,
the speckle pattern consists of far-field diffraction of the holes, and
the transmission matrix is calculated from the size of the holes, the position of the holes, and the free propagation length before the diffuser and the propagation length after the diffuser.
